(19) United States
(12) Patent Application Publication
(10) Pub. No.: US 2020/0332156 A1
(43) Pub. Date: Oct. 22, 2020

(54) ANISOTROPIC CONDUCTIVE FILM, DISPLAY DEVICE INCLUDING SAME AND/OR SEMICONDUCTOR DEVICE INCLUDING SAME

(71) Applicant: KUKDO CHEMICAL CO., LTD., Seoul (KR)

(72) Inventors: Young Woo PARK, Gyeonggi-do (KR); Soon Young KWON, Gyeonggi-do (KR); Chan Ok KIM, Gyeonggi-do (KR); Jae Sun HAN, Gyeonggi-do (KR)

(73) Assignee: KUKDO CHEMICAL CO., LTD., Seoul (KR)

(21) Appl. No.: 16/958,613

(22) PCT Filed: Dec. 20, 2018
(86) PCT No.: PCT/KR2018/016328

§ 371 Date: Jun. 26, 2020

(30) Foreign Application Priority Data
Dec. 29, 2017 (KR) 10-2017-0184883

(51) Int. Cl. C09J 9/02; H01B 5/16; H01B 1/22; C09J 163/00

(52) U.S. Cl. CPC C09J 9/02; H01B 5/16; C08L 23/06; C09J 163/00; H01B 1/22

(57) ABSTRACT

Provided are an anisotropic conductive film, a display device including the same and/or a semiconductor device including the same, the film comprising a conductive layer, wherein the conductive layer is formed of a conductive layer composition containing conductive particles, the conductive particles have a saturation magnetization value and specific gravity satisfying following formulae (1) and (2): (1) about 10 emu/g≤saturation magnetization value≤about 20 emu/g; and (2) about 2.8≤specific gravity≤about 3.2.

### TECHNICAL FIELD

The present invention relates to an anisotropic conductive film, a display device including the same, and/or a semiconductor device including the same. More particularly, the present invention relates to an anisotropic conductive film that can increase a particle mono-dispersion rate before compression and a particle capture rate after compression, and can achieve compatibility between conductivity and insulating properties.

### BACKGROUND ART

Generally, an anisotropic conductive film refers to a film-type adhesive prepared by dispersing conductive particles in a resin, such as an epoxy resin. The anisotropic conductive film is formed of an anisotropic adhesive polymer film which exhibits conductive properties in a thickness direction of the film and insulating properties in an in-plane direction thereof. When an anisotropic conductive film disposed between circuit boards to be connected is subjected to heating/compression under specific conditions, circuit terminals of the circuit boards are electrically connected to one another through conductive particles and an insulating adhesive resin fills spaces between adjacent electrodes to isolate the conductive particles from one another, thereby providing high insulation performance.

In recent years, with further improvement in compactness and resolution of display panels, various studies have been made to capture conductive particles as much as possible in a minimum connection area. For improvement in particle capture rate, a method for increasing the density of conductive particles in a film or a method for suppressing fluid flow using an excess of non-conductive inorganic particles has been studied. However, this method has a drawback in that electric short cannot be prevented due to the absence of the fluid flow.

In general, about 70% of adjacent conductive particles contact one another in the anisotropic conductive film. As compactness and resolution of the display panel are further improved, the minimum connection areas of the conductive particles contacting one another and a distance between electrodes are further decreased, thereby making it difficult to achieve compatibility between conductivity and insulating properties. Increase in input amount of the conductive particles for securing conductivity compromises decrease in input amount of the conductive particles for securing the insulating properties. Therefore, a method for securing conductivity and insulating properties by decreasing the input amount of the conductive particles through increase in particle mono-dispersion rate has been studied in the art.

### DISCLOSURE

### Technical Problem

It is one aspect of the present invention to provide an anisotropic conductive film that can increase a particle mono-dispersion rate before compression and a particle capture rate after compression.

It is another aspect of the present invention to provide an anisotropic conductive film that can secure good conductivity and good insulating properties by achieving compatibility between conductivity and insulating properties.

It is a further aspect of the present invention to provide an anisotropic conductive film that has good reliability of connection resistance.

### Technical Solution

1. One embodiment of the present invention relates to an anisotropic conductive film including a conductive layer, wherein the conductive layer is formed of a conductive layer composition containing conductive particles, the conductive particles having a saturation magnetization value and a specific gravity satisfying the following Relations (1) and (2), respectively:

about 10 emu/g≤saturation magnetization value≤about 20 emu/g; Relation (1):

and

about 2.8≤specific gravity≤about 3.2. Relation (2):

2. In Embodiment 1, the conductive particles may be dispersed in a mono-dispersion rate of 90% or more in the conductive layer.

3. In Embodiments 1 and 2, the conductive particles may include at least one of first conductive particles each including a matrix particle; a metal coat layer surrounding a surface of the matrix particle; and bumps formed on a surface of the meal coat layer, and second conductive particles each including a matrix particle; bumps formed on a surface of the matrix particle; and a metal coat layer surrounding the surface of the matrix particle and the bumps.

4. In Embodiments 1 to 3, the metal coat layer may have a thickness of about 1,000 Å or more and about 2,500 Å or less.

5. In Embodiments 1 to 4, the bumps may be present in a density of about 70% or more.

6. In Embodiments 1 to 5, the conductive particles may have a purity of about 80% or more and about 100% or less.

7. In Embodiments 1 to 6, the metal coat layer may be formed of nickel alone or may include nickel and at least one selected from among boron, tungsten and phosphorus.

8. In Embodiments 1 to 7, the conductive particles may have an average particle diameter (D50) of about 2.5 μm or more and about 6.0 μm or less.

9. In Embodiments 1 to 8, the conductive particles may be present in an amount of about 20 wt % or more and about 60 wt % or less in the conductive layer.

10. In Embodiments 1 to 9, the conductive layer composition may further include a binder resin, an epoxy resin, and a curing agent.

11. In Embodiments 1 to 10, the anisotropic conductive film may further include an insulating layer formed on at least one surface of the conductive layer.

12. Another embodiment of the present invention relates to a display device including the anisotropic conductive film according to Embodiments 1 to 11.

13. A further embodiment of the present invention relates to a semiconductor device including the anisotropic conductive film according to Embodiments 1 to 11.

### Advantageous Effects

The present invention provides an anisotropic conductive film that can increase a particle mono-dispersion rate before compression and a particle capture rate after compression.

The present invention provides an anisotropic conductive film that can secure good conductivity and good insulating properties by achieving compatibility between conductivity and insulating properties.

The present invention provides an anisotropic conductive film that has good reliability of connection resistance.

### BRIEF DESCRIPTION OF DRAWING

FIG. 1 is a view of a matrix particle having bumps formed thereon.

### BEST MODE

Embodiments of the present invention will be described in detail with reference to the accompanying drawings. However, it should be understood that the present invention may be embodied in different ways and is not limited to the following embodiments. The following embodiments are provided for thorough understanding of the invention to those skilled in the art. Thicknesses or widths of various components may be exaggerated for clarity in the drawings.

As used herein to represent a specific numerical range, the expression “a to b” and “a or more and b or less” is defined as “≥a and ≤b”.

Herein, “average particle diameter” means D50. D50 means a particle diameter corresponding to 50% by weight (wt %) in a cumulative curve of mass of particles depending on particle diameter thereof. The particle diameter of the particles may be measured by a particle diameter analyzer but is not limited thereto.

An anisotropic conductive film according to the present invention may include a conductive layer, which may include a matrix and conductive particles contained in the matrix.

The conductive particles have a saturation magnetization value and a specific gravity satisfying the following relations (1) and (2).

about 10 emu/g≤saturation magnetization value≤about 20 emu/g Relation (1):

about 2.8≤specific gravity≤about 3.2. Relation (2):

That is, the conductive particles may have a saturation magnetization value of about 10 emu/g or more and about 20 emu/g or less, for example, 10 emu/g, 11 emu/g, 12 emu/g, 13 emu/g, 14 emu/g, 15 emu/g, 16 emu/g, 17 emu/g, 18 emu/g, 19 emu/g, or 20 emu/g, and a specific gravity of 2.8 or more and about 3.2 or less, for example, 2.8, 2.9, 3, 3.1, or 3.2. Within these ranges of saturation magnetization value and specific gravity, the conductive particles can be efficiently dispersed upon application of a magnetic field to a composition for anisotropic conductive films in manufacture of the anisotropic conductive film, and allows increase in mono-dispersion rate thereof before compression and increase in particle capture rate after compression through arrangement of the conductive particles, thereby providing good conductivity and insulating properties by achieving compatibility therebetween.

In the anisotropic conductive film according to the present invention, the conductive particles may be dispersed in a mono-dispersion rate of about 90% or more, for example, 90%, 91%, 92%, 93%, 94%, 95%, 96%, 97%, 98%, 99%, or 100%, and may be captured in a particle capture rate of about 70% or more, for example, 70%, 75%, 80%, 85%, 90%, 95%, or 100%.

The particle capture rate indicates the number of conductive particles on a terminal before and after compression, as represented by a percentage value and may be measured by the following method, without being limited thereto. First, the number of conductive particles present on the terminal before compression (the number of conductive particles before compression) is calculated by Equation 1.

The number of conductive particles before compression=Density of conductive particles per unit area of conductive layer (number/mm²)×Area of terminal (mm²) [Equation 1]

Thereafter, the number of conductive particles present on the terminal after compression (the number of conductive particles after compression) is measured, followed by calculating the particle capture rate according to Equation 2.

Particle capture rate=(The number of conductive particles after compression/the number of conductive particles before compression)×100(%) [Equation 2]

The number of conductive particles present on the terminal after compression may be counted through a metal microscope, without being limited thereto. Compression is performed under the following conditions:

1) Preliminary compression condition: 60° C., 1 second, 1 MPa

2) Main compression condition: 150° C., 5 seconds, 70 MPa

The particle mono-dispersion rate refers to a ratio of the conductive particles present in a state of being separated from one another (mono-dispersion state) instead of contacting one another in the anisotropic conductive film. The particle mono-dispersion rate may be calculated by the equation: (the number of conductive particles in the mono-dispersion state per unit area (1 mm²) on the anisotropic conductive film)/(the total number of conductive particles per unit area (1 mm²) on the anisotropic conductive film)×100(%).

The conductive particles may include at least one of first conductive particles each including a matrix particle; a metal coat layer surrounding a surface of the matrix particle; and bumps formed on a surface of the meal coat layer, and second conductive particles each including a matrix particle; bumps formed on a surface of the matrix particle; and a metal coat layer surrounding the surface of the matrix particle and the bumps.

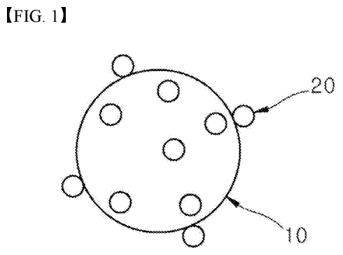

FIG. 1 is a view of the first conductive particle including bumps 20 directly formed on a surface of a matrix particle 10. Although FIG. 1 shows that the bumps 20 are not inserted into the surface of the matrix particle 10, at least some of the bumps 20 may be partially inserted into the surface of the matrix particle 10.

The conductive particles having a saturation magnetization value of about 10 emu/g or more and about 20 emu/g or less and a specific gravity of about 2.8 or more and about 3.2 or less may be obtained by regulating at least one of the thickness of the metal coat layer, the density of the bumps, purity of the conductive particles, and the size (or height) of the bumps.

Preferably, the conductive particles having a saturation magnetization value of about 10 emu/g or more and about 20 emu/g or less and a specific gravity of about 2.8 or more and about 3.2 or less are obtained by regulating the thickness of the metal coat layer, the density of the bumps, and purity of the conductive particles, and are included in the anisotropic conductive film according to the present invention.

The metal coat layer may have a thickness of about 1,000 Å or more and about 2,500 Å or less, for example, 1,000 Å, 1,100 Å, 1,200 Å, 1,300 Å, 1,400 Å, 1,500 Å, 1,600 Å, 1,700 Å, 1,800 Å, 1,900 Å, 2,000 Å, 2,100 Å, 2,200 Å, 2,300 Å, 2,400 Å, or 2,500 Å. Within this range, the conductive particles according to the present invention, which have a saturation magnetization value of about 10 emu/g or more and about 20 emu/g or less and a specific gravity of about 2.8 or more and about 3.2 or less, can be manufactured. The metal coat layer may be formed of a metal, such as Au, Ag, Ni, Cu, solders, and the like. These may be used alone or as a mixture thereof.

The bumps may be present in a density of about 70% or more, preferably about 70% or more and about 95% or less, for example, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, or 95%. Within this range, the conductive particles according to the present invention, which have a saturation magnetization value of about 10 emu/g or more and about 20 emu/g or less and a specific gravity of about 2.8 or more and about 3.2 or less, can be manufactured. Herein, the density of bumps may mean a ratio of the total area of the bumps formed on the surface of the metal coat layer to the total area of the metal coat layer.

The bumps may have a size (or height) of about 150 nm or more and about 200 nm or less, for example, 150 nm, 155 nm, 160 nm, 165 nm, 170 nm, 175 nm, 180 nm, 185 nm, 190 nm, 195 nm, or 200 nm. Within this range, the conductive particles according to the present invention, which have a saturation magnetization value of about 10 emu/g or more and about 20 emu/g or less and a specific gravity of about 2.8 or more and about 3.2 or less, can be manufactured.

The conductive particles may have a purity of about 80% or more and about 100% or less, for example, 80%, 81%, 82%, 83%, 84%, 85%, 86%, 87%, 88%, 89%, 90%, 91%, 92%, 93%, 94%, 95%, 96%, 97%, 98%, 99%, or 100%. Within this range, the conductive particles according to the present invention, which have a saturation magnetization value of about 10 emu/g or more and about 20 emu/g or less and a specific gravity of about 2.8 or more and about 3.2 or less, can be manufactured.

The conductive particles may have an average particle diameter (D50) of about 2.5 μm or more and about 6.0 μm or less, preferably about 3.0 μm or more and about 5.0 μm or less, for example, 2.5 μm, 2.6 μm, 2.7 μm, 2.8 μm, 2.9 μm, 3.0 μm, 3.1 μm, 3.2 μm, 3.3 μm, 3.4 μm, 3.5 μm, 3.6 μm, 3.7 μm, 3.8 μm, 3.9 μm, 4.0 μm, 4.1 μm, 4.2 μm, 4.3 μm, 4.4 μm, 4.5 μm, 4.6 μm, 4.7 μm, 4.8 μm, 4.9 μm, 5.0 μm, 5.1 μm, 5.2 μm, 5.3 μm, 5.4 μm, 5.5 μm, 5.6 μm, 5.7 μm, 5.8 μm, 5.9 μm, or 6.0 μm. Within this range, the film does not suffer from deterioration in insulating properties and allows good dispersion of the conductive particles therein.

In the conductive layer, the conductive particles may be present in an amount of about 20 wt % or more and about 60 wt % or less, preferably about 20 wt % or more and about 50 wt % or less, more preferably about 20 wt % or more and about 40 wt % or less, for example, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, or 60%. Within this range, the conductive particles can be easily compressed between members to be bonded to each other therethrough, thereby securing connection reliability while reducing connection resistance through improvement in current flow.

The first conductive particle may be prepared by a method that includes: forming a metal coat layer on the surface of a matrix particle; and forming bumps on a surface of the metal coat layer. The second conductive particles may be prepared by a method that includes forming a matrix particle having bumps formed thereon; and forming a metal coat layer on the matrix particle having the bumps thereon.

Next, the method of manufacturing the second conductive particles will be described. However, it should be understood that the first conductive particles may be easily manufactured through modification of the method of manufacturing the second conductive particles.

The bumps may be directly formed on the surface of the matrix particle. The matrix and the bumps may be formed through polymerization of an organic monomer.

The process of forming the matrix particle having bumps thereon is performed by forming uniform fine particles through dispersion copolymerization between a first type of monomer having a silane group and a polymerizable unsaturated double bond and a second type of monomer, such as styrene and acryl, followed by promoting crosslinking reaction between chains constituting each of the fine particles through sol-gel reaction as soon as the dispersion copolymerization is completed, in which the monomer having a silane group and unsaturated carbon atoms is used in an amount of about 0.5 wt % or more and about 80.0 wt % or less relative to the total amount of reactants, for example, 0.5 wt %, 1 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, or 80 wt %, in the course of dispersion copolymerization, and pure water is added in an amount of about 0.5 wt % or more and about 15.0 wt % or less, for example, 0.5 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, or 15 wt %, late in radical reaction.

The characteristic preparation method according to the present invention in which the bump type matrix particles are prepared through sol-gel reaction after dispersion polymerization is based on a principle of maximizing phase separation in a fine particle generated during inter-chain crosslinking through sol-gel reaction of an unreacted silane group in the fine particle. That is, when phase separation remarkably occurs through coupling between polymer chains, the density and size of the bumps formed on the surface of the matrix particle can be regulated depending upon the content of the silane group and the degree of crosslinking the fine particles can also be regulated, thereby maintaining compressive hardness and recovery rate for the matrix particles of the conductive fine particles. In addition, since the matrix particle per se has a certain degree of irregularity or more, a stable Ni coat layer can be formed on the fine particles upon electroless plating.

The process of forming the resin matrix particles according to the present invention will be described in more detail. In this process, a monomer, such as methacryloyloxytrime(e)thoxysilane and vinyltrime(e)thoxysilane, which contains both a silane group and unsaturated carbon atoms allowing radical polymerization with the silane group, is completely dissolved together with an initiator and a monomer, such as styrene and the like. Then, the monomer mixture is added to a closed reactor containing a polymer dispersion stabilizer and alcohol, and stabilized under a nitrogen atmosphere for several hours. A small amount of aqueous HCl solution is added to the stabilized reaction product and stirred for several minutes, followed by polymerization at a temperature of about 50° C. or more and about 80° C. or less while stirring at a stirring rate of about 40 rpm or more and about 100 rpm or less for 24 hours. The polymer particles are prepared in fine powder form through washing with alcohol by centrifugation and drying at room temperature under reduced pressure.

Examples of the monomer capable of being used as a monomer for the resin matrix particle and containing both a silane group and an unsaturated double bond include methacryloyloxypropyltrime(e)thoxysilane and vinyltrime(e)thoxysilane. According to the present invention, a silane-based vinyl monomer is preferably present in an amount of about 0.5 wt % or more and about 80.0 wt % or less, more preferably about 1.5 wt % or more and about 50.0 wt % or less, for example, 0.5 wt %, 1 wt %, 1.5 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, or 80 wt %. When the content of the silane-based vinyl monomer is less than about 0.5 wt %, the density of the silane group in the particle is insufficient to promote sol-gel reaction, thereby making it difficult for the conductive particles to exhibit mechanical properties due to insufficient hardness and making it difficult to form the bumps after sol-gel reaction. The density of the bumps may be regulated based on the content of the silane-based vinyl monomer in consideration of solubility with a monomer to be copolymerized therewith. When the content of the silane-based vinyl monomer exceeds about 80.0 wt %, stability of dispersion polymerization can be deteriorated, thereby making it difficult to obtain uniform fine particles.

The resin matrix particles may have an average particle diameter of about 1 μm or more and about 100 μm or less, for example, 1 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, or 100 μm; and the size of the bumps formed on the resin matrix particle may be about 1/50 or more and about ⅕ of the average particle diameter of the matrix particle excluding the bumps, more preferably about 1/25 or more and about 1/10 or less, for example, 1/50, 1/45, 1/40, 1/35, 1/30, 1/25, 1/20, 1/15, 1/10, or ⅕. The number of bumps formed on the resin matrix particle is preferably about 10 or more and about 50 or less per fine particle, more preferably about 15 or more and about 35 or less, for example, 10, 15, 20, 25, 30, 35, 40, 45, or 50.

According to the present invention, the monomer copolymerizable with the silane-based vinyl monomer is a radical polymerizable monomer. Specifically, the monomer copolymerizable with the silane-based vinyl monomer may include styrene, p- or m-methyl styrene, p- or m-ethyl styrene, p- or m-chlorostyrene, p- or m-chloromethyl styrene, styrene sulfonic acid, p- or m-t-butoxy styrene, methyl (meth)acrylate, ethyl (meth)acrylate, propyl (meth)acrylate, n-butyl (meth)acrylate, isobutyl (meth)acrylate, t-butyl (meth)acrylate, 2-ethylhexyl (meth)acrylate, n-octyl (meth)acrylate, lauryl (meth)acrylate, stearyl (meth)acrylate, 2-hydroxy ethyl (meth)acrylate, polyethylene glycol (meth)acrylate, methoxy polyethylene glycol (meth)acrylate, glycidyl (meth)acrylate, dimethylaminoethyl (meth)acrylate, diethylaminoethyl (meth)acrylate, vinyl acetate, vinyl propionate, vinyl butyrate, vinyl ether, allyl butyl ether, allyl glycidyl ether, unsaturated carboxylic acids, such as (meth)acrylic acid and maleic acid, alkyl (meth)acrylamide, (meth)acrylonitrile, and the like. The monomer copolymerizable with the silane-based vinyl monomer is preferably present in an amount of about 20.0 wt % or more and about 99.5 wt % or less, more preferably about 50.0 wt % or more and about 98.5 wt % or less, for example, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 95 wt %, 98.5 wt %, or 99.5 wt %, relative to the total amount of reactants.

The initiator according to the present invention is selected from any initiator typically used in the art. Specifically, the initiator may include peroxide compounds, such as benzoyl peroxide, lauryl peroxide, o-chlorobenzoyl peroxide, o-methoxybenzoyl peroxide, t-butylperoxy-2-ethylhexanoate, t-butyl peroxyisobutyrate, 1,1,3-3-tetramethylbutylperoxy-2-ethylhexanoate, dioctanoyl peroxide, didecanoyl peroxide, and the like, and azo compounds, such as 2,2′-azobisisobutyronitrile, 2,2′-azobis(2-methylbutyronitrile), 2,2′-azobis(2.4-dimethylvaleronitrile), and the like. The initiator may be added in an amount of about 1.0% relative to the total amount of polymerization monomers.

The dispersion stabilizer according to the present invention is a polymer capable of being dissolved in an alcohol phase or a water phase and is limited to a polymer capable of exhibiting stabilizing effects without reaction with a silane group. Specifically, the dispersion stabilizer may include polyvinyl pyrrolidone, polyvinyl alkyl ether, a polydimethylsiloxane/polystyrene block copolymer, and the like. In order to prevent non-uniformity and agglomeration of particles due to sol-gel reaction during dispersion polymerization, the stabilizer may be added in an amount of about 1 wt % or more and about 25 wt % or less, for example, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, or 25 wt %.

According to the present invention, a continuous phase is an alcohol phase and includes methanol, ethanol, n-propanol, isopropanol, n-butanol, t-butanol, and the like. In order to adjust solvency of the continuous phase, an organic compound, such as benzene, toluene, xylene, methoxy ethanol, and the like, may be mixed with the alcohol.

According to the present invention, water may be added to induce sol-gel reaction with silane and is preferably present in an amount of about 0.5 wt % or more and about 15.0 wt % or less relative to the total amount of the reactants, more specifically about 1.0 wt % or more and about 10.0 wt % or less, for example, 0.5 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, or 15 wt %. If the content of the stabilizer is less than about 0.5 wt %, insufficient sol-gel reaction can occur, and if the content of the stabilizer exceeds about 15.0 wt %, stability of the particles can be deteriorated, thereby making it difficult to prepare uniform fine particles due to agglomeration.

For electroless plating corresponding to the second step according to the present invention, a typical electroless plating method is employed. First, bump-type mono-dispersion high crosslinking resin particles are sequentially subjected to alkali degreasing, sensitizing in a SnCl₂ solution, and activation in a PdCl₂ solution, followed by electroless plating to form the metal coat layer. Then, the metal coat layer is regulated to a thickness of about 1,000 Å or more and about 2,500 Å or less. The metal coat layer may be formed of nickel alone or may include nickel and at least one selected from among boron, tungsten, and phosphorus.

Next, an anisotropic conductive film according to one embodiment of the present invention will be described.

The anisotropic conductive film according to this embodiment may be a monolayer film consisting of a conductive layer.

The conductive layer may be formed of a conductive layer composition containing the conductive particles according to the present invention. In the conductive layer composition, the conductive particles may be present in an amount of about 20 wt % or more and about 60 wt % or less, preferably about 25 wt % or more and about 55 wt % or less, more preferably about 30 wt % or more and about 50 wt % or less, for example, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, or 60 wt %, in terms of solid content. Within this range, the conductive particles can be easily compressed between members to be bonded to each other therethrough, thereby securing connection reliability while reducing connection resistance through improvement in current flow.

The conductive layer may have a thickness of about 3 μm or less, preferably about 0.1 μm or more and about 3 μm or less, for example, 0.1 μm, 0.2 μm, 0.3 μm, 0.4 μm, 0.5 μm, 0.6 μm, 0.7 μm, 0.8 μm, 0.9 μm, 1 μm, 1.1 μm, 1.2 μm, 1.3 μm, 1.4 μm, 1.5 μm, 1.6 μm, 1.7 μm, 1.8 μm, 1.9 μm, 2 μm, 2.1 μm, 2.2 μm, 2.3 μm, 2.4 μm, 2.5 μm, 2.6 μm, 2.7 μm, 2.8 μm, 2.9 μm, or 3 μm. Within this range, the conductive layer can secure good connection between a connection structure and the conductive particles.

The conductive layer composition according to the present invention may further include a binder resin, an epoxy resin, and a curing agent.

The binder resin may be selected from among typical resins used in the art without being limited to a particular binder resin. Examples of the binder resin may include a polyimide resin, a polyamide resin, a phenoxy resin, a polymethacrylate resin, a polyacrylate resin, a polyurethane resin, an acrylate modified urethane resin, a polyester resin, a polyester urethane resin, a polyvinyl butyral resin, a styrene-butadiene-styrene (SBS) resin and a modified epoxy resin thereof, a styrene-ethylene-butylene-styrene (SEBS) resin and a modified resin thereof, acrylonitrile butadiene rubber (NBR) and a hydrogenated resin thereof, and the like. These binder resins may be used alone or as a mixture thereof. Preferably, the binder resin is a phenoxy resin, more preferably a biphenyl fluorene phenoxy resin.

In the conductive layer composition, the binder resin may be present in an amount of about 10 wt % or more and about 75 wt % or less, preferably about 20 wt % or more and about 60 wt % or less, for example, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, or 75 wt %, in terms of solid content. Within this range, the binder resin allows efficient layer formation of the anisotropic conductive film while securing connection reliability.

The epoxy resin may include at least one among an epoxy monomer selected from the group consisting of bisphenol type, novolac type, glycidyl type, aliphatic type and alicyclic type epoxy monomers, an epoxy oligomer, and an epoxy polymer. As the epoxy resin, any material having at least one coupling structure selected from molecular structures including bisphenol type, novolac type, glycidyl type, aliphatic type and alicyclic type molecular structures among epoxy monomers known in the art may be used without limitation.

An epoxy resin having a solid phase at room temperature and an epoxy resin having a liquid phase at room temperature may be used together in addition to a flexible epoxy resin.

Examples of the epoxy resin having a solid phase at room temperature may include phenol novolac epoxy resins, cresol novolac epoxy resins, epoxy resin having dicyclo pentadiene as a main backbone, and bisphenol A or F-type polymers or modified epoxy resins thereof, without being limited thereto.

Examples of the epoxy resin having a liquid phase at room temperature may include bisphenol A or F type epoxy resins or combinations thereof, without being limited thereto.

Examples of the flexible epoxy resin may include dimer acid-modified epoxy resins, epoxy resins having propylene glycol as a main backbone, and urethane-modified epoxy resins, without being limited thereto.

In addition, at least one selected from the group consisting of naphthalene, anthracene, and pyrene-based aromatic epoxy resins may also be used, without being limited thereto.

In the conductive layer composition, the epoxy resin may be present in an amount of about 1 wt % or more and about 40 wt % or less, preferably about 10 wt % or more and about 30 wt % or less, for example, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, or 40 wt %, in terms of solid content. Within this range, the conductive layer composition allows easy formation of the anisotropic conductive film and can secure good bonding strength thereof while improving insulating reliability thereof.

The curing agent may be selected from any curing agent capable of curing the binder resin to form an anisotropic conductive film, without limitation. Examples of the curing agent may include acid anhydride, amine, ammonium, imidazole, isocyanate, amide, hydrazide, phenol, and cationic curing agents. These curing agents may be used alone or as a mixture thereof. Further, the curing agent may have a microcapsule shape.

In the conductive layer composition, the curing agent may be present in an amount of about 0.1 wt % or more and about 30 wt % or less, preferably about 0.5 wt % or more and about 20 wt % or less, for example, 0.1 wt %, 0.5 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, or 30 wt %, in terms of solid content. Within this range, the conductive layer composition can prevent deterioration in bonding strength due to excessive increase in hardness of the anisotropic conductive film and deterioration in stability and reliability due to remaining curing agent.

The conductive layer composition may further include non-conductive particles. The non-conductive particles may include insulating particles that impart insulating properties. The insulating particles may include inorganic particles, organic particles, or a mixture thereof. The inorganic particles may include, for example, silica (SiO₂), Al₂O₃, TiO₂, ZnO, MgO, ZrO₂, PbO, Bi₂O₃, MoO₃, V₂O₅, Nb₂O₅, Ta₂O₅, WO₃, In₂O₃, and the like.

According to the present invention, the non-conductive particles may be silica particles. The silica may be silica prepared by a liquid phase process, such as a sol-gel process, a precipitation process, and the like, or silica prepared by a gas phase process, such as a flame oxidation process and the like. In addition, the silica may be non-powder silica prepared through pulverization of silica gel, fumed silica, and fused silica, and may have a spherical shape, a broken shape, or an edgeless shape, without being limited thereto. The non-conductive particles may have an average particle diameter (D50) of about 1 nm or more and about 20 nm or less, preferably about 1 nm or more and about 15 nm or less, for example, 1 nm, 2 nm, 3 nm, 4 nm, 5 nm, 6 nm, 7 nm, 8 nm, 9 nm, 10 nm, 11 nm, 12 nm, 13 nm, 14 nm, 15 nm, 16 nm, 17 nm, 18 nm, 19 nm, or 20 nm. Within this range, the non-conductive particles can prevent increase in connection resistance without obstructing connection between the conductive particles and terminals.

In the conductive layer composition, the non-conductive particles may be present in an amount of about 1 wt % or more and about 20 wt % or less, preferably about 5 wt % or more and about 15 wt % or less, for example, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, or 20 wt %, in terms of solid content. Within this range, the anisotropic conductive film can exhibit good bonding reliability.

The conductive layer composition may further include a silane coupling agent. The silane coupling agent may be selected from any typical silane coupling agent used in the art, without limitation. Examples of the silane coupling agent may include epoxy-containing silane coupling agents, such as 2-(3,4-epoxycyclohexyl)-ethyltrimethoxysilane, 3-glycidoxytrimethoxysilane, and 3-glycidoxypropyltriethoxysilane, amine-group containing silane coupling agents, such as N-2-(aminoethyl)-3-aminopropylmethyldimethoxysilane, N-2-(aminoethyl)-3-aminopropyltrimethoxysilane, N-2-(aminoethyl)-3-aminopropyltriethoxysilane, 3-aminopropyltrimethoxysilane, 3-aminopropyltriethoxysilane, 3-triethoxysillyl-N-(1,3-dimethylbutylidene)propylamine, and N-phenyl-3-aminopropyltrimethoxysilane, mercapto group-containing containing silane coupling agents, such as 3-mercaptopropylmethyldimethoxysilane and 3-mercaptopropyltriethoxysilane, and isocyanate group-containing containing silane coupling agents, such as 3-isocyanatepropyltriethoxysilane and the like. These may be used alone or as a mixture thereof.

In the conductive layer composition, the silane coupling agent may be present in an amount of about 0.01 wt % or more and about 10 wt % or less, preferably about 0.1 wt % or more and about 5 wt % or less, for example, 0.01 wt %. 0.05 wt %, 0.1 wt %, 0.5 wt %, 1 wt %, 2 wt %, 3 wt %, 4 wt %, 5 wt %, 6 wt %, 7 wt %, 8 wt %, 9 wt %, or 10 wt %, in terms of solid content. Within this range, the anisotropic conductive film can exhibit good bonding reliability.

In order to impart additional properties to the anisotropic conductive film without deteriorating fundamental properties thereof, the conductive layer may further include other additives, such as a polymerization inhibitor, an adhesive imparting agent, an antioxidant, a heat stabilizer, a curing accelerator, a coupling agent, and the like. The content of the other additives may be determined in various ways depending upon the user or purpose of the film and is not limited to a particular content.

A method of forming the anisotropic conductive film according to the present invention is not particularly limited and may be selected from typical methods used in the art. The method of forming the anisotropic conductive film does not require a particular apparatus or equipment. The binder resin is dissolved in an organic solvent and other components are added thereto and stirred therewith for a predetermined period of time to prepare a conductive layer composition. Then, the conductive layer composition is deposited to a predetermined thickness on a release film, followed by application of a magnetic field thereto while drying and/or curing, thereby forming a conductive layer. Application of the magnetic field may be performed under conditions of about 1,000 Gauss or more and about 5,000 Gauss or less, for example, 1,000 Gauss, 1,500 Gauss, 2,000 Gauss, 2,500 Gauss, 3,000

Gauss, 3,500 Gauss, 4,000 Gauss, 4,500 Gauss, or 5,000 Gauss.

Next, an anisotropic conductive film according to another embodiment of the present invention will be described.

The anisotropic conductive film may include a conductive layer including the conductive particles according to the present invention; and an insulating layer formed on at least one surface of the conductive layer. The anisotropic conductive film according to this embodiment is substantially the same as the anisotropic conductive film according to the above embodiment except that the insulating layer is further formed on at least one surface of the conductive layer.

The insulating layer may have a thickness of about 20 μm or less, preferably about 1 μm or more and about 20 μm or less, for example, 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, or 20 μm. Within this range, the insulating layer can improve connection reliability and insulating reliability of the anisotropic conductive film.

The insulating layer may be formed of an insulating layer composition that includes a binder resin, an epoxy resin, a curing agent, and non-conductive particles. Details of the binder resin, the epoxy resin, the curing agent, and the non-conductive particles are the same as those of the conductive layer described above.

The insulating layer composition may include about 30 wt % to about 60 wt % of the binder resin, about 30 wt % to about 60 wt % of epoxy resin, about 0.5 wt % to about 1.0 wt % of the curing agent, and about 1 wt % to about 10 wt % of the non-conductive particles in terms of solid content.

The insulating layer composition may further include at least one selected from among the additives and the silane coupling agent described above.

The anisotropic conductive film may have a connection resistance of about 11 or less after reliability testing, as measured by subjecting the anisotropic conductive film placed between a first connection member and a second connection member to preliminary compression at a temperature of 50° C. to 70° C. under load conditions of 1 to 2 MPa for 1 second to 2 seconds and main compression at a temperature of 130° C. to 170° C. under load conditions of 50 to 90 MPa for 5 second to 7 seconds, followed by allowing the anisotropic conductive film to stand under conditions of 85° C. and 85% RH (relative humidity) for 100 hours. Within this range of connection resistance after reliability testing, the anisotropic conductive film can maintain low connection resistance under high temperature/humidity conditions to exhibit improvement in connection reliability. Herein, the connection resistance after reliability testing refers to connection resistance after allowing the anisotropic conductive film to stand under conditions of 85° C. and 85% RH for 100 hours subsequent to the aforementioned preliminary compression and main compression. Connection resistance after reliability testing may be measured by any typical methods in the art without limitation. A non-limiting example of the method for measuring connection resistance after reliability testing is as follows: multiple film specimens are subjected to preliminary compression and main compression and left under conditions of 85° C. and 85% RH for 100 hours. Then, connection resistance of each of the specimens is measured while applying a test current of 1 mA thereto by a 4-probe method using a tester (2000 Multimeter, Keithley Inc.), followed by averaging the measured resistance values. Within this range, the anisotropic conductive film allows the conductive particles to be sufficiently placed on terminals to improve current flow while reducing short between the terminals by suppressing flow of the conducive particles to a space.

The anisotropic conductive film according to the present invention may be placed between a first substrate having the first connection member formed thereon and a second substrate having the second connection member formed thereon to be subjected to heating and compression. The first substrate may be a glass substrate, such as an LCD or PD panel, or a plastic substrate, may act as a terminal for connection to electronic components, and may be formed with the first connection member thereon. The second connection member may be, for example, a flexible printed circuit (FPC), a chip-on-film (COF), a tape carrier package (TCP), a chip-on-plastic (COP), and the like.

A display device according to another aspect of the present invention includes a driver circuit; a panel; and an anisotropic conductive film according to one embodiment of the present invention. Specifically, the panel may be a liquid crystal display (LCD), which is an LCD panel. Further, the panel may be an organic light emitting diode display (OLED), which is an OLED panel.

The display device may be measured by any typical method known in the art without limitation.

A further aspect of the present invention provides a semiconductor device connected by any one of the anisotropic conductive films according to the present invention described above. The semiconductor device may include a wiring substrate and a semiconductor chip. The wiring substrate and the semiconductor chip may be selected from any wiring substrates and semiconductor chips known in the art without limitation. The wiring substrate may include circuits or electrodes formed of ITO or metal interconnects, and IC chips may be mounted at locations of the wiring substrates corresponding to the circuits or electrodes through the anisotropic conductive film according to the present invention.

Next, the present invention will be described in more detail with reference to some examples. It should be understood that these examples are provided for illustration only and are not to be in any way construed as limiting the invention.

### Example 1

Preparation of Conductive Layer Composition

A conductive layer composition was prepared using a phenoxy resin (biphenyl fluorene type phenoxy resin, FX293, Nippon Steel Corporation) as a binder resin, an epoxy resin (alicyclic epoxy resin, Celloxide 2021P, Daicel Corporation), a curing agent (ternary ammonium compound, CXC-1821, King Industries Inc.), conductive particles 1 as listed in Table 1, and silica (Admanano, Admatech Inc.) as non-conductive particles. A saturation magnetization value of the prepared conductive particles was measured using a vibrating sample magnetometer (VSM). Specific gravity of the conductive particles was measured using a solid hydrometer. Thickness of the metal coat layer of the conductive particles was measured using TEM. Density of bumps on the conductive particles was measured using SEM. Purity of the conductive particles was measured using a mass spectrometer.

In terms of solid content, 30 parts by weight of the phenoxy resin, 20 parts by weight of the epoxy resin, 1 part by weight of the curing agent, 40 parts by weight of the conductive particles 1 (see Table 1), and 9 parts by weight of silica were mixed and stirred using a C-mixer, thereby preparing the conductive layer composition.

Preparation of Anisotropic Conductive Film

The prepared conductive layer composition was stirred at room temperature (25° C.) for 60 minutes at a stirring rate not causing pulverization of the conductive particles. Then, the conductive layer composition was deposited to a thickness of 3 μm on a polyethylene base film subjected to silicone release surface treatment and dried at 90° C. for 1 hour while applying a magnetic field of 3,000 Gauss thereto, thereby preparing an anisotropic conductive film.

### Examples 2 to 12

Anisotropic conductive films were manufactured in the same manner as in Example 1 except that the kinds of conductive particles were changed as listed in Table 2.

### Comparative Examples 1 to 4

Anisotropic conductive films were manufactured in the same manner as in Example 1 except that the kinds of conductive particles were changed as listed in Table 2.

Details of the conductive particles used in Examples and Comparative Examples are shown in Table 1.

TABLE 1

| | Average | Saturation | | Thickness | | |
|---|---|---|---|---|---|---|
| | particle | magnetiza- | | of metal | Bump | |
| | diameter | tion value | Specific | coat layer | density | Purity |
| | (μm) | (emu/g) | gravity | (Å) | (%) | (%) |
| Conductive | 3.2 | 10 | 2.8 | 1,500 | 80 | 85 |
| particle 1 | | | | | | |
| Conductive | 3.2 | 10 | 2.8 | 1,700 | 80 | 87 |
| particle 2 | | | | | | |
| Conductive | 3.2 | 10 | 2.8 | 2,000 | 80 | 86 |
| particle 3 | | | | | | |
| Conductive | 3.2 | 10 | 2.8 | 1,900 | 90 | 85 |
| particle 4 | | | | | | |
| Conductive | 3.2 | 10 | 2.8 | 1,800 | 95 | 84 |
| particle 5 | | | | | | |
| Conductive | 3.2 | 10 | 3.0 | 1,500 | 80 | 92 |
| particle 6 | | | | | | |
| Conductive | 3.2 | 10 | 3.2 | 1,700 | 80 | 81 |
| particle 7 | | | | | | |
| Conductive | 3.2 | 15 | 3.2 | 1,500 | 80 | 95 |
| particle 8 | | | | | | |
| Conductive | 3.2 | 20 | 3.2 | 1,500 | 80 | 90 |
| particle 9 | | | | | | |
| Conductive | 3.2 | 10 | 2.8 | 1,800 | 80 | 95 |
| particle 10 | | | | | | |
| Conductive | 3.2 | 10 | 2.8 | 2,200 | 80 | 95 |
| particle 11 | | | | | | |
| Conductive | 3.2 | 10 | 2.8 | 1,600 | 78 | 85 |
| particle 12 | | | | | | |
| Conductive | 3.2 | 8 | 2.8 | 1,500 | 80 | 84 |
| particle 13 | | | | | | |
| Conductive | 3.2 | 22 | 2.8 | 1,500 | 80 | 90 |
| particle 14 | | | | | | |
| Conductive | 3.2 | 10 | 2.6 | 1,600 | 80 | 90 |
| particle 15 | | | | | | |
| Conductive | 3.2 | 10 | 3.4 | 1,700 | 80 | 85 |
| particle 16 | | | | | | |

The anisotropic conductive films of Examples and Comparative Examples were evaluated as to the following properties and results are shown in Table 2.

(1) Mono-dispersion rate (unit: %): A state in which adjacent conductive particles are separated from one another in the anisotropic conductive film is defined as a mono-dispersion state. The mono-dispersion rate of the anisotropic conductive film is calculated by the equation: (The number of conductive particles in a mono-dispersion state in a unit area of 1 mm² on the anisotropic conductive film)/(the number of conductive particles in a unit area of 1 mm² on the anisotropic conductive film)×100(%).

(2) Curing rate (unit: %): 1 mg of the anisotropic conductive film was taken, followed by measuring an initial heating value (H₀) corresponding to an area under a curve in a temperature range of −50° C. to 250° C. at a heating rate of 10° C./min in a nitrogen gas atmosphere using a differential scanning calorimeter (DCS, Q20, TA Instruments, Inc.) and a heating value (H₁) in the same manner after the film was left at 130° C. for 5 seconds on a hot plate. Then, the curing rate was calculated according to Equation 3.

Curing rate (%)=[(H₀−H₁)/H₀]×100 [Equation 3]

(3) Particle capture rate (unit: %): The particle capture rate in each of the anisotropic conductive films manufactured in Examples and Comparative Examples was measured by the following method.

The number of conductive particles on terminals before compression of the anisotropic conductive film (the number of conductive particles before compression) was calculated by Equation 1.

The number of conductive particles before compression=Density of conductive particles in conductive layer (particle number/mm²)×Area of terminal (mm²) [Equation 1]

The number of conductive particles on the terminals after compression of the anisotropic conductive film (the number of conductive particles after compression) was counted through a metal microscope, followed by calculating the particle capture rate according to Equation 2.

Particle capture rate=(The number of conductive particles after compression/the number of conductive particles before compression)×100(%) [Equation 2]

Preliminary compression and main compression were performed under the following conditions.

1) Preliminary compression conditions: 60° C., 1 sec, 1 MPa

2) Main compression conditions: 150° C., 5 sec, 70 MPa

(4) Initial connection resistance (unit: Ω): Initial connection resistance of each of the anisotropic conductive films manufactured in Examples and Comparative Examples was measured by the following method.

Each of the anisotropic conductive films manufactured in Examples and Comparative Examples was subjected to preliminary compression and main compression under the following conditions and connection resistance thereof was measured while applying a test current of 1 mA thereto by a 4-probe method using a tester (2000 Multimeter, Keithley Inc.), followed by averaging the measured resistance values.

1) Preliminary compression conditions: 60° C., 1 sec, 1 MPa

2) Main compression conditions: 150° C., 5 sec, 70 MPa

(5) Connection resistance after reliability testing (unit: Ω): Connection resistance after reliability testing of each of the anisotropic conductive films manufactured in Examples and Comparative Examples was measured by the following method. As in measurement of the initial connection resistance, the anisotropic conductive films subjected to preliminary compression and main compression were left under conditions of 85° C. and 85% RH for 100 hours for high temperature/humidity reliability testing, followed by measuring connection resistance after reliability testing of each of the anisotropic conductive films.

TABLE 2

| | | | | | | Connec- |
|---|---|---|---|---|---|---|
| | | | | | | tion |
| | | Mono- | | Parti- | Initial | resistance |
| | | disper- | Cur- | cle | connec- | after |
| | | sion | ing | capture | tion re- | reliability |
| | Conductive | rate | rate | rate | sistance | testing |
| | particles | (%) | (%) | (%) | (Ω) | (Ω) |
| Example 1 | Conductive | 95 | 95 | 85 | 0.06 | 0.15 |
| | particles 1 | | | | | |
| Example 2 | Conductive | 92 | 85 | 85 | 0.06 | 0.18 |
| | particles 2 | | | | | |
| Example 3 | Conductive | 93 | 86 | 86 | 0.06 | 0.16 |
| | particles 3 | | | | | |
| Example 4 | Conductive | 96 | 85 | 87 | 0.06 | 0.16 |
| | particles 4 | | | | | |
| Example 5 | Conductive | 92 | 86 | 81 | 0.06 | 0.15 |
| | particles 5 | | | | | |
| Example 6 | Conductive | 95 | 85 | 86 | 0.06 | 0.14 |
| | particles 6 | | | | | |
| Example 7 | Conductive | 93 | 86 | 85 | 0.06 | 0.18 |
| | particles 7 | | | | | |
| Example 8 | Conductive | 93 | 85 | 85 | 0.06 | 0.16 |
| | particles 8 | | | | | |
| Example 9 | Conductive | 96 | 84 | 84 | 0.06 | 0.18 |
| | particles 9 | | | | | |
| Example 10 | Conductive | 92 | 85 | 85 | 0.06 | 0.17 |
| | particles 10 | | | | | |
| Example 11 | Conductive | 93 | 86 | 80 | 0.06 | 0.20 |
| | particles 11 | | | | | |
| Example 12 | Conductive | 92 | 85 | 85 | 0.06 | 0.16 |
| | particles 12 | | | | | |
| Comparative | Conductive | 55 | 86 | 82 | 0.1 | 1.25 |
| Example 1 | particles 13 | | | | | |
| Comparative | Conductive | 42 | 85 | 81 | 0.15 | 1.26 |
| Example 2 | particles 14 | | | | | |
| Comparative | Conductive | 72 | 87 | 85 | 0.19 | 2.26 |
| Example 3 | particles 15 | | | | | |
| Comparative | Conductive | 65 | 86 | 83 | 0.12 | 2.58 |
| Example 4 | particles 16 | | | | | |

As shown in Table 2, each of the anisotropic conductive films of Examples had a high particle capture rate and a high mono-dispersion rate of conductive particles before compression while exhibiting good reliability in connection resistance.

Conversely, the anisotropic conductive films of Comparative Examples 1 and 2 each including conductive particles not satisfying the saturation magnetization value within the range of the present invention, and the anisotropic conductive films of Comparative Examples 3 and 4 each including conductive particles not satisfying the specific gravity within the range of the present invention had low mono-dispersion rates of conductive particles before compression and exhibited poor reliability in connection resistance.

It should be understood that various modifications, changes, alterations, and equivalent embodiments can be made by those skilled in the art without departing from the spirit and scope of the present invention.

1. An anisotropic conductive film comprising a conductive layer,
wherein the conductive layer is formed of a conductive layer composition containing conductive particles,
the conductive particles having a saturation magnetization value and a specific gravity satisfying Relations (1) and (2), respectively:
about 10 emu/g≤saturation magnetization value≤about 20 emu/g; and Relation (1):
about 2.8≤specific gravity≤about 3.2. Relation (2):

2. The anisotropic conductive film according to claim 1, wherein the conductive particles are dispersed in a mono-dispersion rate of 90% or more in the conductive layer.

3. The anisotropic conductive film according to claim 1, wherein the conductive particles comprise at least one selected of first conductive particles each comprising a matrix particle; a metal coat layer surrounding a surface of the matrix particle; and bumps formed on a surface of the meal coat layer, and second conductive particles each comprising a matrix particle; bumps formed on a surface of the matrix particle; and a metal coat layer surrounding the surface of the matrix particle and the bumps.

4. The anisotropic conductive film according to claim 3, wherein the metal coat layer has a thickness of about 1,000 Å or more and about 2,500 Å or less.

5. The anisotropic conductive film according to claim 3, wherein the bumps are present in a density of about 70% or more.

6. The anisotropic conductive film according to claim 3, wherein the conductive particles have a purity of about 80% or more and about 100% or less.

7. The anisotropic conductive film according to claim 3, wherein the metal coat layer is formed of nickel alone or comprises nickel and at least one selected from among boron, tungsten and phosphorus.

8. The anisotropic conductive film according to claim 1, wherein the conductive particles have an average particle diameter of about 2.5 μm or more and about 6.0 μm or less.

9. The anisotropic conductive film according to claim 1, wherein the conductive particles are present in an amount of about 20 wt % or more and about 60 wt % or less in the conductive layer.

10. The anisotropic conductive film according to claim 1, wherein the conductive layer composition further comprises a binder resin, an epoxy resin, and a curing agent.

11. The anisotropic conductive film according to claim 1, further comprising: an insulating layer formed on at least one surface of the conductive layer.

12. The display device comprising the anisotropic conductive film according to claim 1.

13. The semiconductor device comprising the anisotropic conductive film according to claim 1.
